(19) United States
(12) Patent Application Publication
(10) Pub. No.: US 2008/0097884 A1
(43) Pub. Date: Apr. 24, 2008

(54) Method Of Lowering The Computational Overhead Involved In Money Management For Systematic Multi-Strategy Hedge Funds

(75) Inventor: Gavin Robert Ferris, County Down (IE)

Correspondence Address: SYNNESTVEDT LECHNER & WOODBRIDGE LLP, P O BOX 592, 112 NASSAU STREET, PRINCETON, NJ, 08542-0592, US

(73) Assignee: CRESCENT TECHNOLOGY LIMITED, Dublin (IE)

(21) Appl. No.: 11/718,787

(22) PCT Filed: Nov. 8, 2005
(86) PCT No.: PCT/GB05/04304

§ 371 Date: May 21, 2007

(30) Foreign Application Priority Data
Nov. 8, 2004 (GB) 0424656.7

(51) Int. Cl. G06Q 40/00; G06F 17/10

(52) U.S. Cl. 705/36 R

(57) ABSTRACT

A data representation is deployed that comprises instances of a software object implementing a particular systematic trading strategy; there are multiple such instances (‘strategy instances’), each corresponding to a different trading strategy, with a strategy instance being paired with a tradable instrument. The method comprises the steps of: (a) each strategy instance providing an estimate of its returns; (b) using Bayesian inference to assess predefined characteristics of each estimate; (c) allocating capital to specific strategy instance/instrument pairings depending on the estimated returns and the associated characteristics. The object based representation is both flexible and powerful; because it directly supports a Bayesian inference, it is functionally better than known approaches because it allows characteristics, such as the reliability of the return estimates to be quantified and modelled and the accuracy of the return estimates to be improved.

### BACKGROUND OF THE INVENTION

1. Field of the Invention

This invention relates to a method of lowering the computational overhead involved in a computer implemented systems that performs ‘money management’ of systematic multi-strategy hedge funds; a data representation is deployed in the system; the representation comprises instances of a software object implementing a particular systematic trading strategy.

Structure of this Document: We begin by reviewing the problems faced by systematic multi-strategy funds, which must provide a common trading platform for multiple trading algorithms within a single risk and ‘money management’ framework. In this initial exposition, we also define certain important terms utilized in the document, for example <strategy instance, instrument(s)> tuples, allocation, trade sizing etc.

Next, a review of the current state of the art is provided, including an analysis of the Markowitz approach to allocation, and the various elements of trade sizing that have been employed from time to time, including the use of ‘fractional Kelly’ systems.

We then proceed to problematize these conventional approaches, showing why their use can often lead to sub-optimal fund performance. We demonstrate why a coherent approach to ‘money management’ for a systematic multi-strat necessarily involves dealing with the methodology of strategy performance prediction, the reliability of these predictions, and managing capital allocation and trade sizing as distinct (but obviously related) operations.

With the shortcomings of the current state of the art established, we then proceed to introduce our own systematic trade flow methodology, termed bScale. The main elements and functional flows utilized by this approach are discussed in some detail. Again, we stress that the bScale approach is not by itself a trading strategy, but rather a methodology through which multiple strategies may be managed with computational efficiency, with an emphasis being placed on estimate reliability. The Bayesian inference models used are also described in this section.

Next, we show how the bScale platform successfully addresses the problems faced by systematic multi-strategy funds, which were earlier rehearsed, and in particular that it provides benefits not enjoyed by practitioners of the current state of the art. Compatibility with existing approaches is also examined.

Finally, we summarize and review the arguments presented in this paper and recap the advantages of the bScale methodology.

2. Description of the Prior Art

Systematic, multi-strategy hedge funds are lightly regulated vehicles normally invested in by high net worth individuals and institutions. These funds are termed systematic because they attempt to make money through the use of algorithmically expressed trading strategies (implemented, for the vast majority of such firms, as computer software). Multi-strategy funds attempt to derive an additional ‘edge’ (as their name suggests) through the use of a number of such trading programmes, which may be diversified over underlying instrument type, geography, holding period, risk factor exposure etc.

However, while a well executed multi-strategy fund can generally outperform any of the individual constituent strategies executed alone, these types of vehicle also face a serious money management problem, viz.: just how should capital be assigned between the various competing strategies, in order to optimise overall performance (as expressed by an appropriate objective function)?

In the current art, there have been two major approaches taken to the issue of money management, namely the Markowitz mean-variance-optimization (MVO) analysis and the Kelly system. The former is generally more commonly used for ‘allocation’ decisions (slower-moving general bindings of capital to strategies) whereas the latter is more commonly utilised for ‘trade sizing’ decisions (how much capital to put at risk on any particular trade).

However, although these quite different approaches may be reconciled, even considered together they are not sufficient to solve the general problem of money management. This is because:
they do not address the reliabiliy of each trading strategy's return estimates (which may wax and wane over time as the strategy becomes more or less well matched to the underlying market);
they do not explicitly address the creation of trade performance prediction functions (the outputs of which are required to calibrate e.g., an MVO);
and not do they provide a mechanism to mediate between the allocation provided to a strategy in virtue of its general (long-run) performance, versus the sizing of any particular trade that strategy may emit.

As a result of these omissions, sub-optimal money management methodologies have been employed by many multi-strats. Some examples of this include: feeding a strategy's ex ante return estimates directly into an MVO, closing out existing trades to make room for new recommendations despite costs, and estimating a strategy's future mean performance as a simple moving average of past performance, etc.

The Capital Assignment Problem for Multi-Strategy Systematic Hedge Funds

Multi-strategy hedge funds (‘multi-strats’) are groups that seek to pursue multiple, distinct trading strategies under the banner of a single hedge fund product. bScale is targeted at systematic multi-strats (that is, where computer software, and not human investment advisors, are used to make the trading decisions), as this type of fund construction has the capacity to be managed in a much more sophisticated manner than those that do not (essentially, because systematic funds can be reliably simulated against potential outcome scenarios). bScale is also concerned with strategies that utilise trading instruments that may easily be marked to market (such as exchange traded futures, equities, bonds etc), rather than those which cannot (e.g., private equity holdings, certain OTC credit derivatives, etc) since the former clearly provide more accurate position risk reporting.

That having been said, the techniques here may also be of application to hedge fund-of-funds (FoFs) that use networking technology to create a virtual multi-strategy framework by explicitly risk-budgeting segregated trading accounts in a meaningful subset of their underlying funds. The creation of this type of virtual multi-strat is covered in detail in the Crescent Technology Ltd. patent application PCT/GB2005/003887, the contents of which are incorporated by reference. Furthermore, there may be a number of funds that employ only a small number of systematic strategies (for example, trend followers who may utilise essentially the same trading technology over multiple time frames) for whom the techniques described herein are relevant.

Some Key Definitions

The main issue dealt with in this paper is that of capital assignment by systematic multi-strategy hedge funds to their underlying <strategy instance, instrument(s)> tuples. Let us now define the meaning of that second term.

We assume that within the embodiment of the trading decision system (generally in computer software), that multiple instances of a software object (each implementing a given trading strategy algorithm) may be created, where each instance has its own internal state. To allow trading, each instance must be associated with one or more underlying instruments (e.g., a gold future, a CFD on the DJSTOXX automotive index, a government bond of a particular duration, etc.) One strategy instance may be associated with a single instrument (this is perhaps the most common situation), or it may deal with multiple (as in a long-short strategy or a statistical arbitrage basket trader). We call this association a <strategy instance, instrument(s)> tuple (a tuple is simply a collection). Of course, an instrument may be traded by multiple strategy instances if desired.

The key issue for multi-strats is: having decided upon the set of such <strategy instance, instrument(s)> tuples, how much of the fund's capital should be assigned to any given tuple at any given time? This is commonly referred to as ‘money management’ or ‘capital assignment’ problem.

Now, there are actually two related but distinct processes at work here, which are often not clearly separated, and they are capital allocation and trade sizing. The first of these, capital allocation, refers to the percentage of total fund assets that is reserved, at any specific moment, for the potential use of a given <strategy instance, instrument(s)> tuple. The second, trade sizing, refers to the utilization of that allocated capital for any particular trade recommendation (at a particular point of time) of a particular tuple's strategy instance.
Money management=capital allocation+trade siting

What's more, a good money management system should be as complete as possible, addressing questions such as:
What are the precise boundaries of capital allocation and trade sizing? Where does one start and the other begin?
All allocation and assignment decisions are based upon some forecast of performance (and potential interaction) between multiple strategies. How are such forecasts created?
How are the forecasts checked for reliability, and how are unreliable strategies dealt with?
How can forecasting method deal with multiple competing predictive methods?
How can the forecasting method deal with a shift in underlying market regime?
How is overfitting of the performance forecasting model to the data prevented?
How can the user constrain the overall risk profile of the system?

As will become clear, these questions are generally not well addressed by the techniques currently in use within the investment management community. These techniques tend to fall into two schools: portfolio approaches using Markowitz mean variance optimization (MVO), and more trade-driven approaches using (fractional) Kelly sizing. We will now examine each of these techniques, and demonstrate their similarity. Then, we will look at their shared difficulties (including the fact that they offer no explicit prescription for the performance forecasting problems just enumerated).

Review of Current Art

Historical Motivation

The current art for ‘money management’ has largely evolved from two distinct camps—‘long only’ portfolio managers on the one side, and CTAs (commodity trading advisors, involved in the proprietary trading of futures) on the other.

For the former group, the important thing has been to understand the behaviour of the underlying instruments themselves (particular equities, bonds etc.), assuming they are going to be composed into a long-term, and generally (but not necessarily) long-only, portfolio. Trades in such a scenario are made relatively infrequently. This world-view led to the creation of the Markowitz framework, or mean-variance optimization, according to which one optimizes a portfolio in terms of maximizing the portfolio's return per unit variance, by taking advantage of diversification between instruments that do not have 100% correlation of returns.

By contrast, CTAs looked much more to the concept of an active trading strategy applied to an underlying instrument. Long and short trading has been more commonly utilised. Instruments traded are generally margined derivatives: these tend to have daily settlement of any profit or loss, and, as such, no market value—the participants merely having to put up a ‘good faith deposit’ (margin) to help validate that they are able to meet the daily settlement. Margin is generally a relatively small percentage of the nominal value of a contract, meaning that high levels of leverage are straightforward to achieve. This being so, it is often possible for traders to concern themselves only with the opportunities posed on each trade as it comes along, allowing the overall level of leverage to expand in periods of ‘feast’ rots of simultaneous trades) and contract in periods of ‘famine’ (few candidate trades), subject to overall risk budgets. Given this background, it is unsurprising that attention has tended to focus on the question of how much to risk each trade of a given strategy, given an overall expectation for that strategy, in order to optimize the log growth rate of the asset base.

As we shall see, both approaches (Markowitz and Kelly) share a large amount of common ground. However, it is worth briefly here that they also suffer common shortfalls: neither contains recommendations about how the expected returns or covariance (whether or instruments or trading strategies) should be estimated in the first place, or how reliability of these estimates should be taken into account; neither utilises the shape of the distribution rather than point estimates; neither deals with handling multiple predictive models of a single underlying instrument.

Nevertheless, let us now turn to look at each of these two mainstream approaches in turn, as this will lay a useful foundation on which the ‘other questions’ may be more adequately explored.

Markowitz Mean-Variance Optimization (MVO)

It is probably fair to say that the mainstream money management approach that has been used over the last 40 years has been the Markowitz mean-variance framework. (Harry M. Markowitz, “Portfolio Selection,” Journal of Finance 7, 1 (1952)).

This framework assumes that:
Returns (often in practice taken to be log returns) of programme assets are normally distributed, and each may therefore be completely characterized by a distinct long-run mean return and variance of that return (plus covariance to the returns of other programme assets). Note that the mean-variance framework was originally applied to individual assets, rather than trading strategies applied to underlying assets, but the concepts are similar; it can be applied to strategy returns also. However, when this is done the periodicity of trading becomes a key variable to understand.
Volatility, computed as the square root of variance of return, is (essentially) a sufficient measure of risk.
The objective to be optimized is expected portfolio return divided by expected portfolio volatility (this may be made more sophisticated through the use of utility-derived risk aversion functions, the adoption of a risk-free rate, or the use of multi-period geometric means rather than arithmetic, (see David Wilkinson, Mean-Variance Optimization and Modern Portfolio Theory) but the basic concept remains).

The MVO approach seeks to harness diversification, by building portfolios of assets whose returns have less than total correlation with each other. Where this is so, the expected mean of the composite portfolio is found simply by multiplying the portfolio weights into the vector of expected asset (or strategy) returns; however, the expected volatility will be lower than the weighted average of the component volatilities.

For example, consider a simple portfolio where we have two assets, A and B, which have expected mean returns μ_{A} and μ_{B}, and standard deviation of returns σ_{A} and σ_{B}. Suppose further that these assets have a covariance of σ_{B} and a correlation coefficient of ρ_{B}. Then if the relative weights of the assets in the portfolio are represented by w_{A} and w_{B}, such that w_{A}+w_{B}=1, then we have the portfolio expected return μₚ and volatility σₚ:
μₚ=w_{A}μ_{A}+w_{B}μ_{B}
σₚ=\sqrt{(w_{A}²σ_{A}²+w_{B}²σ_{B}²+2w_{A}w_{B}σ_{AB})}

And of course the covariance may be calculated as a function of the individual volatilities and the correlation coefficient, viz.:
σ_{AB}=ρ_{AB}σ_{A}σ_{B}

As may be appreciated, where the correlation is <1, diversification benefits ensue from selecting a well matched portfolio of A and B—the result can have a better expected return/volatility ratio than either of the constituents.

Now, clearly this approach can be extended to a portfolio of n assets 1 . . . n, with expected returns μ₁ . . . μₙ expressed as a column matrix μ, weights w₁ . . . wₙ (summing to 1) also expressed as a column matrix w and covariance matrix σᵢⱼ, then we have portfolio expected return μₚ and volatility σₚ:

$${μ}_{p} = {w}^{T} i = ( \begin{matrix}{w}_{1} & {w}_{2} & … & {w}_{n}\end{matrix} ) ( \begin{matrix}{μ}_{1} \\ {μ}_{2} \\ … \\ {μ}_{n}\end{matrix} )$$

$${σ}_{p} = \sqrt{{w}^{T} {{o}^{r}}_{ij} w} = {( ( \begin{matrix}{w}_{1} & {w}_{2} & … & {w}_{n}\end{matrix} ) ( \begin{matrix}{σ}_{1}^{2} & {σ}_{12} & … & {σ}_{1 n} \\ {σ}_{21} & {σ}_{2}^{2} & … & {σ}_{2 n} \\ … & … & … & … \\ {σ}_{n 1} & {σ}_{n 2} & … & {σ}_{n}^{2}\end{matrix} ) ( \begin{matrix}{w}_{1} \\ {w}_{2} \\ … \\ {w}_{n}\end{matrix} ) )}^{\frac{1}{2}}$$

The ‘efficient frontier’ is then the set of lowest σₚ for the μₚ defined by each possible instance of w.

Of course, certain assumptions must be made and modifications to methodology assumed when extending this approach to deal with <strategy instance, instrument(s)> tuples, rather than simply holding positions in instruments directly. One particular problem is whether to focus on the long run overall expectation of each strategy i as the μᵢ, or the expectation of a particular trade. The problem is that if we focus on the latter, then a strategy with no viable trade may find itself without available capital allocated when a suitable trade subsequently emerges, that capital having been allocated to other tuples with trades in progress (and, potentially, costs of liquidation). To deal with this scenario, a reasonable approach is to allow the μᵢ to represent the long-run mean expectations of the strategy, and then fractionally allocate from this (even this approach has difficulties, however, in that if there are trades that fall below the mean, there must by definition be those that exceed it also; these latter trades should have greater than 100% of the mean capital allocated to them, which implies use of increased leverage in ‘feast’ conditions). Nevertheless, use of a mean-variance optimization focussed on mean long-run returns and covariances for capital allocation, with fractional takeup of this allocation to any given trade on the basis of a function of the current trade expectation and the long run strategy expectation for trade sizing, is one of the more common hedge fund money management strategies in use today.

Now, while this approach has the benefit of relative simplicity, it suffers from a number of problems which we will address shortly. Before we do that however, let us look at one other major approach commonly used by CTAs (commodity trading advisors) and hedge funds for money management, namely Kelly (or often, fractional Kelly) trade sizing.

Fractional Kelly Money Management

In 1965, a mathematician named John Kelly, working at Bell Labs, wrote a pioneering paper (John L. Kelly, Jr., “A New Interpretation of Information Rate,” Bell System Technical Journal (July 1956)) that led to the creation of a money management system named after him. Kelly applied earlier information theoretic work by C. E. Shannon to the question of optimal bet sizing for a gambler with an ‘edge’ (namely, foreknowledge of the underlying event transmitted to him, but over a ‘noisy’ communication channel, so that the message might arrive garbled). Kelly demonstrated that if the probabilities of correct transmission were known, and the payoff/loss was known, and if the trial could be repeated many times, then there would be a mathematically optimal amount to place on each trial, to optimize the growth rate of the underlying capital in log space.

This has been applied to trading by CTAs in the following manner: estimate (usually through analysis of past history) the expected win probability W for trading a particular <strategy instance, instrument(s)> tuple. Then calculate ratio R_{WL} of the average amount of a win to the average amount of a loss. The Kelly fraction (in practice, the largest fraction of total capital that should be risked on any trade of the tuple) is:
KF=W−((1−W)/R_{WL})

For example, suppose that the outcome of a particular strategy has historically produced a profit 55% of the time (W=0.55) with an average profit of 1.2% and an average loss of −1.0% (RWL=1.2/1.0=1.2). Then the Kelly fraction is:
KF=0.55−((1−0.55)/1.2)=0.55−(0.45/1.2)=−0.175=17.5%

Therefore, the optimal amount to risk per trade based upon the Kelly criterion and the provided information, is 17.5% of equity. This is a fractional criterion, in that the amount risked should always be 17.5% of remaining capital, regardless of whether (e.g.) this capital has recently increased due to a winning trade, or been depleted due to a losing one.

Now, this approach, while theoretically correct, does suffer from the requirements of a ‘long run’ view (which may exceed a manager's window to retain assets, in the case of a sequence of losing trades); and, it also assumes that the win loss return ratio does not degrade, and that the probability of a win also does not degrade.

As a heuristic way of dealing with this, many practitioners scale back the recommended Kelly trade size systematically, resulting in an approach known as fractional Kelly. Such systems greatly reduce the overall downside risk when used in practical environments.

Unifying the Markowitz and Kelly Frameworks

Notwithstanding the preceding, a number of difficulties remain when attempting to apply the Kelly approach to a portfolio multi-strategy fund, which must (by definition) be able to support simultaneous trades issued by potentially different systems. The main three such difficulties are:
1. We need to deal with the competition between multiple concurrent trading opportunities, the sum of the optimal Kelly fractions of which may exceed 1 (or the maximum leverage allowed).
2. The outcomes of the trades are likely to be non-independent; therefore, we have to have some regard to their degree of interconnection; we cannot simply compute their Kelly fractions in a vacuum.
3. The returns of strategy trading will almost certainly follow some form of continuous distribution, not simply a discrete ‘win/loss’ outcome set (unless exotic derivatives, such as hold-to-expiry binary options, are involved). This being so, the standard Kelly formula will not suffice.

These issues were addressed by Edwin O. Thorpe in an important paper, published in 1997 (“The Kelly Criterion in Blackjack, Sports Betting, and the Stock Market,” The 10th International Conference on Gambling and Risk Taking (Montreal, June 1997)). There, he showed through the use of a binomial approach for a single asset (which is then generalized to a portfolio of such assets) that there was an equivalence between the Kelly and CAPM frameworks, wherein a ‘Kelly investor’ has an effect a utility function of the form U(σₚ,μₚ)=μₚ−_σₚ²=c. Under this approach, where we have a covariance matrix σᵢⱼ, a risk free rate column vector r and an estimated tuple return column vector μ, then the optimal weight vector w may be calculated as follows:
w=σᵢⱼ⁻¹(μ−r)

This is also the optimal portfolio solution to the conventional Markowitz problem posed earlier, with the Kelly investor levering or delivering along the capital market line according to opportunity (the solution to the conventional quadratic programming problem is well known in the literature—see e.g., Campbell Harvey's paper “Optimal Portfolio Control” (http://www.duke.edu/˜charvey/Classes/ba350/control/opc.htm: Duke University, Apr. 12, 1995).

Summary of the Current Art

In the foregoing we have described the two main methodologies that are currently utilized by market practitioners for money management; namely, the standard Markowitz mean variance optimization framework, and the (fractional) Kelly approach. As we have seen, under certain circumstances (e.g. assumption of log normal returns) the two approaches, taken with respect to a portfolio of assets/<strategy instance, instrument(s)> tuples, converge.

Clearly, there are a number of other approaches that are also in use, ranging through the unsophisticated (e.g. fixed fraction of asset based used) through to more esoteric. However, we believe that the majority of market participants in the multi-strategy arena to be using (in effect) the ‘overall approach’ defined by the unified Markowitz/Kelly.

However, as we outlined at the start of this document, there are serious problems with the Markowitz/Kelly approach, in large part because it does not provide a complete answer to the money management problem. We will now turn to look at these limitations in more detail.

Summary of Key Problems Faced by Current Approaches

The Markowitz/‘portfolio’ Kelly approach clearly has certain advantages for portfolio sizing. However, there are a number of important problems as well. Some of the more important are:
The use of standard ‘covariance’ methodology assumes underlying normality of returns (usually, in log space). This has actually little support in practice, even when holding a portfolio of native instruments directly, since returns for most instrument show a degree of leptokurtosis (fat ‘tails’ to their probability distribution functions (PDFs)) (see Alexander M. Ineichen, Absolute Returns: The Risk and Opportunities of Hedge Fund Investing, Wiley Finance Series (Hoboken, N.J., USA: John Wiley & Sons, Inc, 2003). This problem is actually exacerbated when dealing with <strategy instance, instrument(s)> tuples, rather than underlying instruments directly, since many strategies, particularly systematic ones, explicitly aim to create higher moments in their PDFs. For example, trend following strategies generally cut losing trades very aggressively, while allowing winners to run, creating PDFs that have a strong ‘option-like’ quality to them (skew). This point is made forcefully in the document ‘Trend Following: Performance, Risk and Correlation Characteristics’ published by Graham Capital Management (http://www.trendfollowing.com/whitepaper/trendfollowing.pdf: Graham Capital Management, May 3, 2003).
Both the Markowitz and (portfolio) Kelly framework are reliant upon prior estimation of the estimated mean returns and covariance matrix for each strategy. Neither system addresses explicitly how such estimates should be arrived at, how to measure the running accuracy of predictions, or how to factor in potential error even where this accuracy has been estimated. However, these issues are clearly extremely important, as ‘garbage in=garbage out’.
In reality, many practitioners resort to using simple statistical estimators to generate the future mean expected return and covariance (essentially, taking past returns and feeding them into a standard statistical analysis package). Unfortunately, this leads to variable quality results. The hedge fund literature shows that strategy covariance tends (while not stationary) to be relatively stable and so using conventional estimators is a reasonable thing to do; but strategy returns are more highly variable (see Richard Horwitz, Hedge Fund Risk Fundamentals: Solving the Risk Management and Transparency Challenge (Princeton, N.J., USA: Bloomberg Press, 2003). Therefore, using a mean-of-past-returns estimator with a finite window may lead, in effect, to ‘backing last month's winners’, particularly where the ‘regime’ of the underlying market changes with a mean frequency higher than that defined by the sampling window. This latter point applies even when more sophisticated models (e.g. a multi-factor regression) are used to create return forecasts.
The Markowitz/Kelly approach does not address clearly how the problem of money management should be split between asset allocation (the amount to set aside for a trading strategy at any time as a proportion of assets managed, even though it may not currently have any viable trade) and trade sizing (the amount of that allocation to put at risk on a particular trade when the opportunity does occur).

Crescent created the bScale methodology to address these issues explicitly, and thereby provide a complete ‘end-to-end’ solution for money management. It addresses also the over-riding requirement for computational efficiency—an important feature for a computer implemented system that, ideally, should be able to perform simultaneous, real-time money management of very large numbers of trading strategies and instruments. We will now review the bScale approach in more detail, after which we will demonstrate that it provides significant benefits when compared to the current art, and that it addresses the difficulties for current systems that have just been discussed.

### SUMMARY OF THE INVENTION

The invention is a method of lowering the computational overhead involved in a computer implemented system that performs money management of systematic multi-strategy hedge funds, wherein a data representation is deployed that comprises instances of a software object implementing a particular systematic trading strategy, there being multiple such instances (‘strategy instances’), each corresponding to a different trading strategy, with a strategy instance being paired with a tradable instrument; the method comprising the steps of:
(a) each strategy instance providing an estimate of its returns;
(b) using Bayesian inference to assess predefined characteristics of each estimate;
(c) allocating capital to specific strategy instance/instrument pairings depending on the estimated returns and the associated characteristics.

The object based representation is both flexible and powerful; because it directly supports a Bayesian inference, it is functionally better than known approaches because it allows characteristics, such as the reliability of the return estimates to be quantified and modelled and the accuracy of the return estimates to be improved. Explicit modelling of reliability would, in prior art systems, introduce considerable computational complexity. The present invention is therefore more computationally efficient that the prior art: a computer implemented system (e.g. a workstation) can, if using the present invention, simultaneously analyse more trades in continuous real time operation than an equivalent conventional system enhanced to model the reliability of all return estimates and continuously enhance the accuracy of the models. Equally, workstations programmed to perform money management across a given number of underlying trading strategies and instruments would require less computational power if they adopt the present invention, compared to those that use a conventional approach. This low overhead of implementation is an important technical advantage.

Determining separately (a) capital allocation for a strategy instance/instrument pairing and (b) trade sizing for that pairing is facilitated.

Further, each strategy instance provides the estimate of returns in the format of a Gaussian model; Bayesian inference is used to regression fit the Gaussian models.

Time can be split into timesteps, the duration of the smallest being determined by the most frequent strategy, with all estimates being updated on each timestep. A specified input data vector for each timestep may be mapped onto a trade duration-return codomain. The trading strategy instance can specify the domain for the function. The strategy instance can also specify the functional form for the Bayesian/Gaussian inference through specification of a covariance function. Hyperparameters of each functional form are optimized against the data to find the most probable parameters θ_{MP}.

Multiple models for a single strategy instance can be ranked against one another using an evidence maximization approach; only the most probable model can then be used. Alternatively, all models are used, being first weighted by probability and then summed.

The strategy instance can also provide explicitly parameterized models that are not Gaussian.

The Bayesian inference results in a PDF (probability density function) for trade frequency and another for trade duration-return; the PDF for trade frequency can be computed using Bayesian inference utilising a Poisson distribution prior. The duration-return and trade frequency PDFs can be combined, with the use of a separate estimate of the underlying parameters, given the triggering of a trading signal, to create a long-run return-per-unit-time PDF.

It is also possible to create a compound predictive model, where the long-run PDF is supplemented by a cross-strategy covariance estimate. The cross-strategy covariance estimate can be derived through a factor-analysis of the returns of simulation, combined with an historical simulation for evolution of those factors.

The performance of capital allocation can be by a routine, which is provided by the long-run PDF and strategy covariance estimates; this routine can be a mean-variance optimizer. The routine could instead utilizes Monte Carlo or queuing theory; the user could also explicitly provides their own model.

Capital allocation can be executed according to one of a number of paradigms, including conservative feasible execution, symmetric feasible execution, pre-emptive execution against costs or full pre-emptive execution.

Trade sizing can be performed against the particular output of a current prediction function and the predicted performance for a particular trade is then mapped against the expected long-run performance, to create a relative leverage to use. Mapping can be done by comparing means or modes of the duration-normalized return (specific trade->long run), and then scaling appropriately, or a probability density weighting can be used. Input data can also be automatically pruned to the latest n-points to keep the matrix inversion required feasible; an approximate matrix inversion approach can be utilised to allow longer windows of analysis.

A comparison of the chosen, θ_{MP} parameterized model against a ‘null’ model is utilised, over a number of datapoints which is itself set through Bayesian optimization but which will be small relative to the longer window. A transition from a non-null model to the null model causes the longer window to be restarted at that point.

An outer control loop may be provided as a final constraint to the capital allocation; the control loop may operate through the computation of VaR (value at risk). The constraint can be fed back as a global multiplier to the size of a single ‘unit’ of allocation, applying equally to all strategies. Any changes through this process may be implemented pre-emptively.

Crescent's bScale Platform

As noted earlier, the present invention is implemented in bScale. bScale is the name given by Crescent to a systematic trading framework that implements the present invention; it has been designed to address the problem of multi-strategy money management directly, and thereby to enable (in conjunction with existing techniques) an ‘end-to-end’ solution to the problems just described. It is important to understand that bScale is not, by itself, ‘yet another trading strategy’, but rather a methodology to allow multiple systematic strategies to co-exist in a principled manner and compete for use of the available fund capital.

bScale is heavily based upon Bayesian principles (hence the ‘b’ in the name ‘bScale’). Bayes theorem (discussed later in this document) provides a principled way of updating prior ‘beliefs’ about the world (expressed as probability distribution functions, or PDFs) as new evidence arrives. Within bScale, Bayesian inference is used to adapt performance prediction functions for trading strategies, to select between multiple candidate prediction functions, to calibrate estimates of trading frequency, and for a number of other important tasks. Importantly, the Bayesian approach maintains distribution functions, rather then point estimates (e.g. means) at all times; this is beneficial when dealing with strategies the performance of which is not well described by a normal distribution (e.g., well executed trend following).

The advantages of the bScale methodology include its computational efficiency, principled approach to reasoning under uncertainty, its incorporation of reliability estimation into money management and its ability to deal with non-normal return distributions.

### BRIEF DESCRIPTION OF THE DRAWINGS

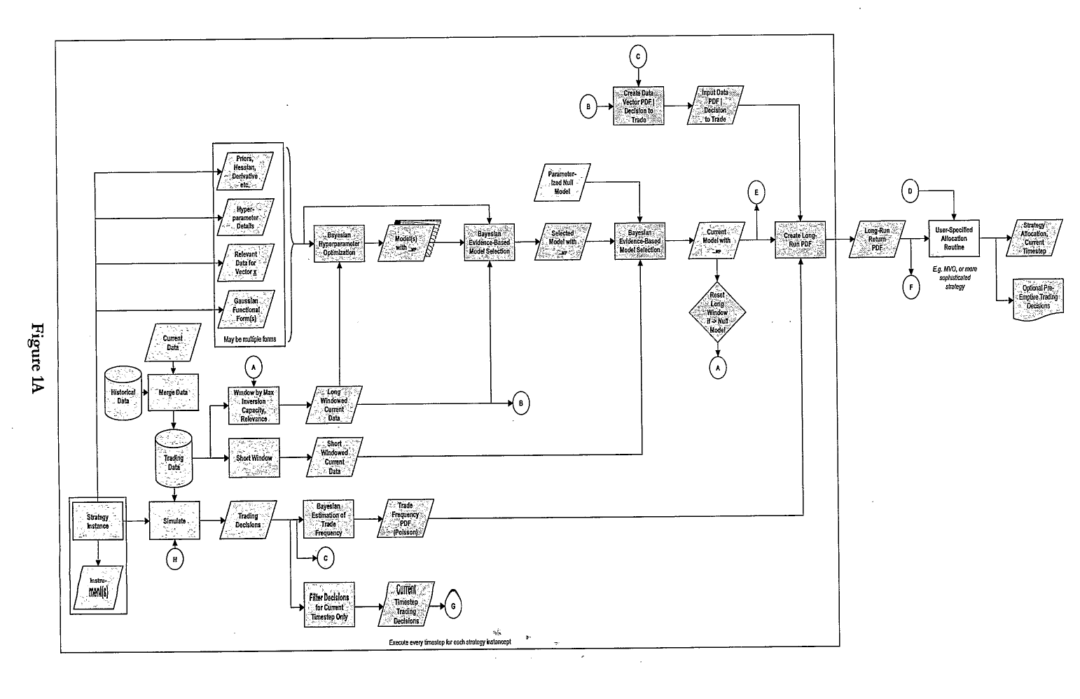

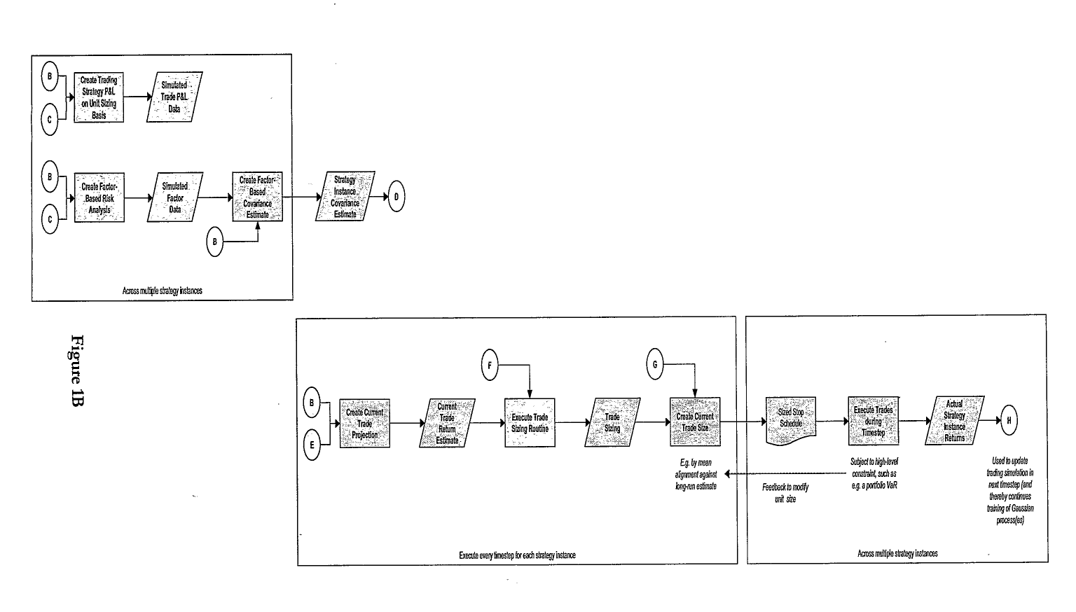

The present invention will be described with reference to the accompanying FIGS. 1A and 1B, which form a schematic of the overall flow in an implementation of the present invention

### DETAILED DESCRIPTION

### Description of the bScale Methodology

The bScale methodology aims to provide a complete, computationally efficient solution for multi-strats, through which they may perform capital assignment in a unified manner between multiple competing <strategy instance, instrument(s)> tuples.

bScale utilizes Bayesian inference extensively. We will now review the mechanics of this and the way it is utilised within the framework. Although Bayesian inference is a known technique in the art, the manner in which it has been applied to a money management system within the bScale framework is novel.

Bayesian Inference

Bayes' theorem allows us to make effective inferences in the face of uncertainty. It connects a prior outlook on the world (pre-data) to a posterior outlook on the world, given the impact of new data.

The basic theorem may be written:

$$P ( w \text{\vert} D , α , {H}_{i} ) = \frac{P ( D \text{\vert} w , α , {H}_{i} ) P ( w \text{\vert} α , {H}_{i} )}{P ( D \text{\vert} α , {H}_{i} )}$$

$$or$$

$$posterior = \frac{likelihood x prior}{evidence}$$

The Bayesian approach allows us to rationally update previously held beliefs (the prior, P(w|α, Hᵢ)) in light of new information D, for a hypothesis model Hᵢ, against a causal field of information, α, where w is a parameter vector for the model. The use of Bayesian estimators in statistics is increasingly regarded as the superior view; traditional (‘frequentist’) statistical approaches must make use of a wide variety of different estimators, choosing between these based upon their sampling properties; there is no clear or deterministic procedure for doing so. By contrast, Bayesian methods make inference mechanical, once the appropriate prior assumptions are in place (See David C. MacKay, Information Theory, Inference, and Learning Algorithms (Cambridge, U.K. New York: Cambridge University Press, 2003)). The methodology applied in bScale to enable return model estimation (without overfitting) is parametric Gaussian modelling; we shall briefly review it here.

Use of Gaussian Processes for Nonlinear Parametric Models

The basic premise utilized is that the transfer function between input data vector xₙ of relevance (including at least the price history of the traded instrument(s)) and the data that we wish to predict (a <return, trade duration> tuple) is modeled by a nonlinear function y(x), parameterized by the vector w. Adaptation of this model to the data presented corresponds to inference of the underlying (‘generator’ function). The ‘target’ output (return-duration estimate for a trade recommendation) at time n is denoted tₙ, so that we have the tuple {xₙ, tₙ}. The set of input vectors up to time N we denote as X_{N}, the set of corresponding results we denote as t_{N}.

This inference is described by the posterior distribution:

$$P ( y ( x ) \text{\vert} {t}_{n} , {X}_{n} ) = \frac{P ( {t}_{N} \vert y ( x ) , {X}_{N} ) P ( y ( x ) )}{P ( {t}_{N} \text{\vert} {X}_{N} )}$$

The likelihood in this inference is generally assumed to be a separable Gaussian distribution; the prior distribution is implicit in the choice of parametric model and choice of regularizer(s). Our approach here follows the exposition of Mark Gibbs' Ph. D. thesis “Bayesian Gaussian Processes for Regression and Classification,” (Ph.D. thesis, Cambridge University, 1997).

For our purposes, a member of the input data vector xₙ at any time n should include a flag from the strategy indicating the number of units (an undiversified metric of risk) that should be held at that time. Positive units indicate a long position in the underlying; negative short. 0 indicates no units are held. Generally, the impact of the risk free rate can be omitted for modeling our Bayesian regression.

The goal is then to predict future values of t given the assumed prior P(y(x)) and the assumed noise model P(t_{N}|y(x), X_{N}); any parameterization of the function y(x; w) is irrelevant. The basic idea is to generate a prior P(y(x)) directly on the space of functions, without setting parameters for y; the prior we use is a Gaussian process, which is a Gaussian distribution generalized to an infinite dimension function space. It is fully specified by its mean and a covariance function. The mean is a function of x (often=0) and the covariance a function C(x, x′) expressing the expected covariance between the outputs of the function t and t′ at these points. The function y(x) being mapped is assumed to be a single sample from this (function) distribution. See Gibbs (op. cit.) for more details on this point.

Next, assume that we have a set of fixed basis functions φₕ(x) (say H of them) and we define the N×H matrix R to be the matrix of values of each of these basis functions at the points in X_{N}. Then assuming y_{N} to be the vector of y(x) at each of these points, we have:

$${y}_{n} ≡ {\sum }_{h} {R}_{n , h} {w}_{h}$$

Where wₕ is the weight assigned to the w^{th} basis function. Assuming w to be Gaussian with 0 mean and variance σ²_{w}, then y as a linear function of these is also Gaussian and also has 0 mean. In which case, the covariance matrix of y is (given 0 mean):
Q=ε(yy^{T})=ε(Rww^{T}R^{T})=Rε(ww^{T})R^{T}=σ_{w}²RR^{T}

Therefore the prior distribution of y is a normal distribution with mean 0 and variance σ²_{w}RR^{T}. Assuming that the target values differ from the function outputs by additive Gaussian noise of variance σ²ᵥ, then t also has a Gaussian prior distribution P(t) of mean 0 and covariance Q+σ²ᵥI=C. The {n, n′} entry of C is:

$${C}_{n , {n}^{′}} = {σ}_{w}^{2} {\sum }_{h} {ϕ}_{h} ( {x}_{n} ) {ϕ}_{h} ( {x}_{{n}^{′}} ) + {δ}_{n , {n}^{′}} {σ}_{v}^{2}$$

$$where {δ}_{n , {n}^{′}} = 1 if n = {n}^{′} , else 0$$

Therefore, the prior probability of the N target values (t) is:

$$P ( t ) = Normal ( t ; 0 , C ) = \frac{1}{Z ( C )} {ⅇ}^{- \frac{1}{2} {t}^{T} {C}^{- 1} t}$$

Where Z(C)=(det(C/2π))⁻, a normalizing constant.

Now, to actually perform the inference of t_{N+1} given t_{N}, we need to calculate the conditional distribution P(t_{N+1}|t_{N})=P(t_{N+1}, t_{N})/P(t_{N}), which is also Gaussian. Our new covariance matrix for the N+1 point is constructed from the old C_{N} matrix as follows:

$${C}_{N + 1} = [ \begin{matrix}[ {C}_{N} ] & [ k ] \\ [ {k}^{T} ] & [ κ ]\end{matrix} ]$$

And the posterior distribution is:

$$P ( {t}_{N + 1} \text{\vert} {t}_{N} ) ∝ {ⅇ}^{- \frac{1}{2} [ {t}_{N} {t}_{N + 1} ] {C}_{N + 1}^{- 1} [ \begin{matrix}{t}_{N} \\ {t}_{N + 1}\end{matrix} ]}$$

Using a method due to Barnett we then have out estimators for the next point and an ‘error bar’ around that point, as follows:

$${\hat{t}}_{N + 1} = {k}^{T} {C}_{N}^{- 1} {t}_{N} . \\ {σ}_{{\hat{t}}_{N + 1}}^{2} = κ - {k}^{T} {C}_{N}^{- 1} {t}_{N}$$

A number of ‘standard forms’ of Gaussian covariance functions may then be used. Some of the more relevant are presented in Gibbs (op. cit.).

Once a model has been specified, the problem remains of optimizing its hyperparameters. For example, a popular form of C is:

$$C ( x , {x}^{′} {e}^{′} ) = {θ}_{1} {ⅇ}^{- \frac{1}{2} {\sum }_{t = 1}^{I} \frac{{( {x}_{i} - {x}_{i}^{′} )}^{2}}{{r}_{i}^{2}}} + {θ}_{2}$$

Here, the θ₁ hyperparameter defines the vertical scale of variations, and the θ₁ allows an overall offset away from 0. x is an I-dimensional vector, with rᵢ being a lengthscale associated with input xᵢ. In this case, how does one optimize (θ₁, θ₂, {rᵢ})?

Ideally, we would integrate over the prior distribution of the hyperparameters:
P(t_{N+1}|x_{N+1}, D, C(.))=∫P(t_{N+1}|x_{N+1}, è, D, C(.))P(è|D, C(.))dè

Where C(.) represents the form of the covariance function. However, this is generally intractable, so either we can approximate the integral by using the most probable values of θ, θ_{MP}, or we can integrate over 0 numerically, using Monte Carlo. The approach taken in bScale is to create derivatives of the evidence for the hyperparameters with respect to each hyperparameter, and then use this to execute a search for the most probable θ, θ_{MP}. This approach is known as evidence maximization, and assumes that:
P(t_{N+1}|x_{N+1}, D, C(.))≈P(t_{N+1}|X_{N+1}|x_{N+1}, è_{MP}, D, C(,))

Which in turn relies upon the assumption that the posterior distribution over 0 is sharply peaked around θ_{MP} relative to variation in P(t_{N+1}|x_{N+1}, θ, D, C(.)); generally this is a reasonable approximation in practice.

Now, we can see that we may evaluate the posterior probability of θ thus:
P(è|D)∝P(tₙ|xₙ,è)P(è)

Hence, taking logs, we have the evidence for the hyperparameters:

$$ln ( P ( {t}_{n} \vert {x}_{n} , è ) ) = - \frac{1}{2} ln ( det ( {C}_{N} ) ) - \frac{1}{2} {t}_{N} {C}_{N}^{- 1} {t}_{N} - \frac{N}{2} ln ( 2 π )$$

The derivative for which, with respect to a generic hyperparameter θ is:

$$\frac{\partial }{\partial θ} ln ( P ( {t}_{n} \vert {x}_{n} , è ) ) = - \frac{1}{2} trace ( {C}_{N}^{- 1} \frac{\partial {C}_{N}}{\partial θ} ) + \frac{1}{2} {t}_{N}^{T} {C}_{N}^{- 1} \frac{\partial {C}_{N}}{\partial θ} {C}_{N}^{- 1} {t}_{N}$$

Therefore, bScale requires that in addition to supplying candidate Gaussian models and associated hyperparameter sets for fitting, strategy instances must also supply derivatives with respect to the hyperparameters, and sensible (e.g. Gamma or inverse Gamma distribution) priors for the hyperparameters (P(θ)).

Then, gradient descent is used to find θ_{MP}, and error bars on this derived from evaluating the Hessian at θ_{MP}. Let:

$$A = - ∇ ∇ ln ( P ( è {\vert D \vert}_{{è}_{MP}} ) ) then$$

$$P ( è \vert D ) \approx P ( {è}_{MP} \vert D ) {ⅇ}^{- \frac{1}{2} {( è - {è}_{MP} )}^{T} A ( è - {è}_{MP} )}$$

Therefore the posterior can be approximated (locally) as a Gaussian with covariance matrix A⁻¹.

Model Comparison Via Bayesian Evidence Estimation

However, a further subtlety emerges where there are multiple functional forms suggested by a strategy instance. In this case, we need a way to determine the relative strengths of the models. Here, the approach taken is to tank models through the use of evidence estimation, and use only the strongest model.

Evidence estimation works by considering that the posterior probability of each model, Hᵢ, is:
P(Hᵢ|D)∝P(D|Hᵢ)P(Hᵢ)

Where Hᵢ represents model i. Generally, when ranking hypotheses, equal priors P(Hᵢ) may be assumed, and so this term is dropped, and therefore the most important computation becomes P(D|Hᵢ). Note that the usual normalizing constant PD) is also omitted, since this unnecessary when computing ratios and also tends to be computed via a summation over all models, (tricky, since the number of models may expand dynamically).

Then we are left with the statement of the model with respect to its parameters θ:
P(D|Hᵢ)=ƒP(D|è, Hᵢ)P(è|Hᵢ)dw

Assuming a strong peak at the most probable parameters θ_{MP}, we can apply an extension of Laplace's method to obtain the appropriate ‘Occam factor’:

$$P ( D \vert {H}_{i} ) \approx P ( D \vert {è}_{MP} , {H}_{i} ) \underbrace{P ( {è}_{MP} \vert {H}_{i} ) {det}^{- \frac{1}{2}} ( \frac{A}{2 π} )}_{‘ Occam factor ’}$$

The evidence, P(D|Hᵢ) is then evaluated for each model, and the model with the highest explanatory power is preferred at each step. Note that it is also possible to fully calculate the probabilities associated with each model, and then use this to produce a fully integrated answer. However, for simplicity the default mode used by bScale is that of selection.

This discussion has shown how bScale utilises Bayesian techniques to build (potentially) multiple return predictive functions for each strategy instance, based upon information provided by that instance, and then selects the most likely strategy at each step.

We can now proceed to examine the overall bScale flow in a little more detail.

Overall bScale Process

The approach may be summarized as follows: strategy instances are responsible for providing Gaussian predictive functional forms (specified as covariance functions) which have a number of (specified) hyperparameters, together with appropriate derivatives and priors, as just outlined. The ‘alpha characterization’ process overall proceeds as follows:
The bScale system operates by splitting time up into quanta termed ‘timesteps’. A single timestep can be a trading day, hour, minute or shorter period, as determined by the most frequent strategy. Generally, where there are significant differences in strategy timescales, it is more convenient, and supported within bScale, to use an event-driven timestep, with a regular ‘end of long period’ event being inserted into the queue (this is frequently done at the close of a trading day, for example). The bScale system updates all its estimates etc. on each timestep (or less frequently, for very short term trading).
bScale requires strategy instances (associated with instrument(s)) to provide ‘Gaussian functional form’ models for their ‘duration-return’ PDF estimators, per the previous discussion. An important point here is that the strategy instance may have multiple ‘classes’ of trade; for example, a simple trend following strategy may issue long and short trades on a given instrument, and it is possible that these two classes of trade have quite separate behaviours. This is accommodated within bScale's Gaussian framework by allowing strategies to supply custom ‘state’ information (essentially, this becomes part of the vector x of input data for each timestep). These models have specified input data sets and hyperparameters; any model priors and the derivative and Hessian must also be supplied by the strategy instance. bScale currently supports fitting of models utilising Gaussians. A more general approach is also, envisaged in which Monte Carlo methods are used to drive the inference of the posterior.
Strategies are run systematically in a ‘backtest’ mode against the historical data; that is, they are required to make trading decisions timestep to timestep. Questions of allocation are ignored at this point, with strategies having access to a unit level capital at the start of all trades. However, all results are normalized to the average amount of equity utilized in the trade (as margin etc.). Strategies that use inherent trade sizing are required to scale so that their ‘full allocation’ represents the initial unit level. For such dynamic strategies, the unit level is assumed to fluctuate with overall account equity, assuming that the equity at the outset of the trade was 1.
The first estimate that is constructed from the results of the backtest is a distribution describing the estimated number of ‘trades’ in a given period for each strategy instance. This utilizes straightforward Bayesian inference over a Poisson distribution prior; it does not use Gaussians. (We refer to the result of this inference as the ‘trade frequency PDF’.)
The second (concurrent) estimate is the PDF (probability density function) covering the return on a trade, given that a trade has been recommended; the estimated point is of form {duration of trade, return} (we refer to this, naturally enough, as the ‘duration-return PDF’). This joint conditional distribution is produced through Bayesian inference of Gaussians, as described in detail in the preceding section. An important point to consider is the size of the dataset. When considering a scientific process, we can generally assume a constant underlying generator process without ‘regime switching’, so the more input data, the better. However, with trading systems the possibility of the market having multiple states cannot be discounted, such that the correct model for one period of time may cease to apply subsequently. There is also another issue—we need to be able to invert the covariance matrix C_{N}, which scales in computational cost with order N³. This starts to become prohibitive for large numbers of points (say, >1000) but there are approximation methods to the inversion that reduce this load. Nevertheless, a reasonable approach is to construct an artificial comparison model which is simply constrained to map to 0 mean for all x, with a variable standard deviation, which is set to a short lookback, for example 100 points. This overall lookback may also be optimized as a hyperparameter, using Bayesian methods if desired. Model plausibility ranking is then utilised, against the functional form selected as most plausible from the large-scale process. Should the simpler model better explain the more recent data, the data for the large-scale process is truncated. Only transitions from an active model to a neutral model cause truncation. Otherwise, data is simply dropped once the outer bounds of computational feasibility are reached. (See Gibbs, op. cit., for a discussion on the use of approximate (and faster) techniques for inversion, which can help raise the maximum data window size significantly).
These two distributions are then combined to create an overall performance estimate for the <strategy instance, instrument(s)> tuple, as a function of assigned equity per unit time. This is also a PDF, which will generally have (due to the combination of the Poisson and Gaussian underlying distributions) a single mode (although this may be negative for unsuccessful strategies, or have a high standard deviation in the case of inconsistent returns or widely spread trade recommendations.) (We refer to the resulting PDF as the ‘long-run return’ estimate.) We first create a PDF for the input data vector x, conditional upon the emission of a trading decision (‘signal’) by the strategy instance. This is then combined with the return estimate PDF (conditional upon a trade signal) and the frequency of trading signal generation PDF to create the overall long-run expectation PDF.
Based upon the results of the backtesting history, a covariance matrix between the <strategy instance, instrument(s)> tuples is calculated. bScale supports two ways to approach this: either direct estimation, based upon the actualized returns (and assuming unit initial equity assignment per unit time), or a factor-based approach, which tends to be more accurate. According to the latter, the actual trades of each strategy created during the back-test are split out for estimation into a series of exposures to risk factors (through a multi-factor regression, which again uses the Bayes/Gaussian approach); this set of risk factors is then utilised to create a predictive risk factor model which creates the covariance matrix estimate for time T+1.
Then, at the beginning of each timestep, the long-run return estimate and covariance estimate is fed into an allocator routine. This process is user-specified, and can vary from a simple MVO (mean variance optimizer) to a more sophisticated approach using Monte Carlo simulation (thereby utilizing potential higher statistical moments present in the PDFs).
The results of this allocation procedure (a schedule of capital allocations) are then transformed into a set of net required changes (a rebalancing schedule).
At this point, bScale supports four explicit paradigms, as follows:
   Conservative feasible execution. Any elements of the rebalancing schedule that can be executed (and which do not require the use of capital currently tied up in an open position, whether as performance-bond margin or market value) are performed. Others are not. Even where the allocations are increased to a strategy with an open position, the size of that open position is not increased (this only takes place when the strategy opens a new trade).
   Symmetric feasible execution. As for conservative feasible execution, but with the exception that where allocations are increased to a tuple with an open position, the size of that position is increased.
   Pre-emptive execution against costs. The current costs (unrealised losses of a mark, costs of increasing a position size) are computed as a derivative (relative cost/unit reduction/increase) and this is utilised to produce another constrained maximization problem similar to the original allocation (this actually replaces the allocation computation, rather than following on from it). Only those reallocations with a positive expectation of utility are executed. However, this involves issuing a rebalancing schedule the execution of which is mandatory, whether or not it involves closing out (or indeed extending) existing positions.
   Full pre-emption. The rebalancing schedule is regarded as mandatory. Any required changes in equity allocation are executed at the beginning of the trading period, regardless of cost.
Now, when capital is allocated to a <strategy instance, instrument(s)> tuple, that capital is, in effect, reserved for use by that tuple. Should that strategy instance not have any trade recommendation at that particular timestep, then the capital will lie fallow (it will, of course, earn interest at the risk free rate).
However, suppose that a strategy instance does recommend a trade at a particular time point. The current duration-return predictor (vide supra) is used to create a PDF that is then utilised to create an estimate of current expected return from the particular trade plus expected duration—this is then marginalised over duration to generate a unit timestep return estimate. This is compared with the long-run estimate for the strategy that was used to drive the allocator, through a trade sizing function. bScale provides a number of modules to carry out such trade sizing, or the user may specify their own. A common strategy applied is to utilise leverage (or partial usage) on an individual position through the ratio of the mean (alternatively, mode) of the expected particular trade return to that of the long-run mean (modal) return (i.e., so that if the long run expectation were 1.0% and the expectation on a particular trade was 0.7%, then 70% of the allocation would be utilized; alternatively, if the particular expectation was 1.5%, then the capital would be 50% leveraged. The various types of trade must be distinguished here; for a futures position, margin/equity is likely to be around 10-20% in any event, so an increased position leverage does not equate to a cash borrowing requirement per se. However, on an equity position, borrowing would be required—in which case, the sizing algorithm must factor in the costs of borrowing. See Richard Horwitz, Hedge Fund Risk Fundamentals: Solving the Risk Management and Transparency Challenge; (Princeton, N.J., USA: Bloomberg Press, 2004) for a useful discussion on leverage. More sophisticated approaches may also be utilised (for example, creating a ‘pessimistic’ estimate by offsetting expected returns on individual trades by n standard deviations, including the particular trade standard deviation in the scaling calculation, scaling so as to weight by the distribution of return expressed in the long-run PDF, with an aim to generate the mean (or modal) allocation over time, given that the trades continue to be representative of the long-run distribution, etc.).
Within a timeslot, the binding of a unit of trade sizing is assumed to remain constant. This means that a strategy instance can, in effect, issue a contingent stop schedule (list of trigger price levels for each instrument, paired with the number of contracts of the instrument to buy or sell should each level be reached) that is good for the whole timestep.
bScale allows the overall allocation/trade sizing approach to be subject to overriding portfolio constraint checks. These can be supplied by the user, and a number of standard constraints are supplied as well. These portfolio constraints are functions, which take as input a set of user-defined parameters and the current portfolio construction (and underlying pricing data), and output a global scaling factor (known as the ‘global risk multiplier’, or GRM). The GRM is used to scale the unit sizing for all strategy instances within the portfolio. Once again, bScale supports this scaling being applied conservatively, symmetrically etc. It is possible to implement ‘caps’ on certain objective functions using this approach, or to target specific values of the objective function. Caps are generally preferred.
One example of a specific cap that is supported by bScale is the use of a portfolio Value at Risk (VaR) metric (see Philippe Jorion, Value at Risk: the Benchmark for Controlling Market Risk, 2nd ed (New York London: McGraw-Hill, September 2000) for a good introduction to VaR). The VaR of the portfolio is calculated at the start of each timestep. Should the VaR exceed a target pre-set by the user (e.g. 2% of equity on a one-day basis at a 95% confidence level), then the ‘unit’ of trade sizing is reduced globally. Once again, this can then be followed through in a pre-emptive or non-pre-emptive fashion, according to user preference. VaR limits can also be imposed before execution of any trade—the portfolio post the trade is checked for compliance and the trade is then either permitted, scaled or rejected based upon this constraint.
This general characterization of each strategy, as generated historically, consisting of the <trade frequency PDF, duration-return PDF>, is continuously updated with each timestep during the trading process as actual results are obtained, thereby updating the models (i.e., the inference is continued ‘on line’, an attractive feature of this methodology). Note that for analysis purposes, trade simulations are always normalized to a standard unit size.
   An important side effect of sizing unit standardization in simulation is that a characterization of a strategy instance can continue to evolve even where allocation to that strategy instance has locally been sent to 0 (or close to 0) by the allocator (for example, due to lack of relative performance).

A summary of the process and data flow involved in the bScale system is shown in FIGS. 1A and 1B.

Miscellaneous Points

There are a few additional points that are worth mentioning to complete the description of the bScale flow, as follows:
The input data vector x can include information that is not simply related to the price history of the underlying instrument(s). For example, it may utilize fundamental data, or output variables computed by the strategy instance itself. Another important class of input data involves information taken from the options (and other forward-looking) markets. For example, a strategy instance may use the implied volatility at a certain time horizon of the underlying as an input; or future correlations may also be utilized.
The methodology is compatible with the production of explicit, parameterized duration-return (and even trade frequency) PDFs from the strategy instance. In this case, the derived models are simply passed to the evidence-based comparator along with a default model supplied by the framework itself; if the strategy model is better, it will be used. Note, however, that this requires the strategy instance to supply an estimate of the evidence P(D|Hᵢ) in support of the model (whether computed by Laplace's method, Monte Carlo, or exactly).
Although model ranking followed by selection is the base bScale methodology, it bears repeating that the framework also supports the more complex mode of operation, whereby the outputs of the various models are simply weighted by relative model probability and then summed. This provides a fully smooth transition to low or no capital allocation in the case of a strategy that has historically performed reliably according to the predictions yielded by its current model, but which subsequently begins to perform less well. The base approach will have more of a ‘square edge’ effect in this circumstance, although the system complexity is greatly reduced thereby.
The methodology does maintain broad compatibility with the ‘Kelly-Markowitz’ framework. The overall target allocations for the system can still utilize a mean-variance optimization (or a portfolio Kelly approach), based upon the mode or mean of the long-run PDF and the factor based covariance matrix; this will be found to yield reasonable performance. However, a more sophisticated approach to allocation is also possible, which (for example) can utilize the explicit distribution of the long run PDF (e.g., a skew to the right as may be evident in trend following strategies).
   Advantages of the bScale Methodology

We have now outlined in some detail the bScale methodology developed by Crescent. In comparison with the current art, what are the main advantages of this approach?

To begin with, the system is capable of providing a return estimate that is likely to be more accurate than a simple ‘mean of strategy performance to date’. This is because a multi-variate regression is automatically fitted using a Gaussian process model, against functional forms and candidate independent-variable data provided by the strategy instance, with the ability to ‘regime shift’ where necessary. Many candidate models can be simultaneously compared, and the predictor is updated ‘on line’. The model predicts a joint distribution over return and holding period given that a decision to trade has been made on that timestep; the bScale approach also computes an estimate of the trading frequency distribution. These are combined as described earlier to generate an expected, long-run distribution for each strategy instance. Not only is this approach more likely to generate an accurate point estimate (mode or mean) than the techniques in the current art, it also creates a distribution function, which allows strategy-specific features (such as skew) to be utilized by the allocator, if desired.

The bScale approach is also superior, as regards duration-return estimation, than approaches which, for example, attempt a simple multi-factor regression, and measure fit sufficiency by an approach such as the r² against each factor. This is the case because of the automatic hyperparameterization, ability to use multiple models, and the ability to deal with regime shifts in a principled manner.

Nevertheless, the bScale approach does not prevent strategy instances from offering explicit duration-return PDFs, and the allocation methodology is such that existing approaches, such as Markowitz mean variance optimization (MVO), can be utilized if desired. Therefore, there is a high degree of compatibility with existing approaches, and firms shifting to the use of bScale can utilize the approach in a modular fashion according to need.

Importantly, bScale offers a coherent approach to the issue of allocation versus trade sizing. bScale treats allocations as being reservations of capital against the (mode or mean) performance of each <strategy instance, instrument(s)> tuple. Particular trades are estimated explicitly as a prediction from the current duration-return PDF, and this is then mapped by the trade sizing algorithm into a relative leverage.

bScale also enables the management, with a single, coherent framework, of relatively heterogeneous strategies (e.g., long and short term trading timescales, single instrument and basket trading approaches, wide and narrow return distributions, etc.) This makes it an extremely valuable approach for multi-strats. The automatic inference of likely duration-return PDFs and trade frequency PDFs makes the integration of a new strategy (found to be broadly successful in backtesting, but with little other characterization) to be integrated coherently into an existing portfolio of strategies. The ability to specify an overall constraint (or target) such as a maximum portfolio VaR, further increases the flexibility of the platform.

In short, the bScale system offers systematic multi-strategy funds a coherent end-to-end approach to managing money management, that is broadly compatible with existing practices, has a low overhead of implementation, and offers higher accuracy of capital assignment. Compared with the generally utilized current art of Markowitz/Kelly, bScale provides a significant step forward in capability for the utilizing find.

Summary

In this document, we have considered the problem of money management as it applies to systematic, multi-strategy hedge funds (multi-strats). We reviewed traditional approaches utilized by many practitioners, and demonstrated that these had serious shortcomings. Subsequently, we introduced our bScale methodology, and described in detail the process and data flows involved. The underlying mathematical basis for the system (Bayesian inference, with a Gaussian adaptive model for duration-return estimation) was also presented. Finally, we described the core advantages of the bScale framework compared with the current art.

In summary, the bScale methodology provides a consistent, low-overhead, high-performance methodology for multi-strats, which can be introduced in a modular fashion into an existing systematic flow.

Key Features within the Scope of the Present Invention

An integrated framework for money management designed to cope with the complex asset assignment problems experienced by systematic multi-strategy hedge funds.
The framework explicitly splits out i) the creation of the performance estimation function for each strategy instance, from ii) capital allocation (against the projected overall long-run performance of that strategy instance), from iii) trade sizing (using specific predictions for a particular trade).
Use of a flexible, Bayesian approach to inferring the characteristics of a strategy.
   Where this inference is used to drive adaptation of a Gaussian process model (to perform the regression)
      Where this model maps a specified input data vector for each timeslot onto a trade duration-return codomain.
      Where the trading strategy instance can specify the domain for said function, so that the input data could be simply a single-timeslot return for the underlying instrument(s), or could be more complex, including e.g. fundamental data, option data, custom variables produced from the strategy instance itself, etc
      Where the trading strategy instance specifies the functional form for said Gaussian inference (through specification of the covariance function).
         Where the hyperparameters of the each functional form are optimized against the data (see definition of data) to find the most probable parameters θ_{MP}.
         Where multiple models for a single strategy instance are ranked against one another using an evidence maximization approach.
         And where only the most probable is used
         Or where all models are used, being first weighted by probability and then summed.
      Or where the trading strategy provides other, explicitly parameterized models (these need not be Gaussian); note that this can seamlessly integrate with the above approach.
   Where this inference results in a PDF (probability density function) for trade frequency and another for trade duration-return.
      Where the PDF for trade frequency is computed using Bayesian inference utilising a Poisson distribution prior.
   Where the duration-return and trade frequency PDFs are combined, with the use of a separate estimate of the underlying parameters, given the triggering of a trading signal, to create a long-run return-per-unit-time PDF.
Creation of a compound predictive model, where the long-run PDF is supplemented by a cross-strategy covariance estimate.
   Where this is derived through a factor-analysis of the returns of simulation, combined with an historical simulation for evolution of those factors.
Performance of capital allocation by a routine, which is provided the long-run PDF and strategy covariance estimates (together with other data generated as part of the analysis).
   Where this routine is a mean-variance optimizer.
   Where it instead utilizes Monte Carlo or queuing theory to provide a more sophisticated response
   Where the user explicitly provides their own model.
Capital allocation can be executed according to one of a number of paradigms, such as conservative feasible execution, symmetric feasible execution, pre-emptive execution against costs or full pre-emptive execution (see text for details).
System performs trade sizing against the particular output of the current prediction function. The predicted performance for a particular trade is then mapped against the expected long-run performance, to create a relative leverage to use.
   In the basic system, this may be done by comparing means or modes of the duration-normalized return (specific trade->long run), and then scaling appropriately.
   More sophisticated approaches may be user coded; we envisage at least that probability density weighting will be used.
The system updates its estimates etc. each period. May also cause the underlying model (duration-mean) to change.
   This update takes place on-line (i.e. model analysis is continuous).
The system is based around timeslots (smallest single time period); these may vary from implementation to implementation.
   For very short term trading, an event-driven model may be adopted, with a regular update on important period boundaries (such as end-of-day).
Input data is automatically pruned to latest n-points to keep the matrix inversion required feasible.
   Approximate matrix inversion approaches may be utilised to allow longer windows of analysis.
   Comparison of the chosen, (MP parameterized model against a ‘null’ model is utilised, over a number of datapoints which is itself set through Bayesian optimization (or by explicit user specification) but which will be small relative to the longer window.
      Where a transition from a non-null model to the null model causes the longer window to be restarted at that point.
The ability to use an outer control loop to provide a final constraint on the system.
   Where this is through the computation of VaR (value at risk).
   Where the constraint is fed back as a global multiplier to the size of a single ‘unit’ of allocation, applying equally to all strategies.
      Where any changes through this process (whether the objective function is couched in terms of VaR or otherwise) are implemented pre-emptively, etc. (see text).

Note that, although the system is described as targeted at multi-strats, they are simply a case where the need is strongest; other hedge funds, and even standard CTAs (futures traders) should find the framework beneficial. The present invention includes within its scope the use of the framework in such contexts.

1. A method of lowering the computational overhead involved in computer implemented systems that perform money management of systematic multi-strategy hedge funds, wherein a data representation is deployed that comprises instances of a software object implementing a particular systematic trading strategy, there being multiple such instances (‘strategy instances’), each corresponding to a different trading strategy, with a strategy instance being paired with a tradable instrument; the method comprising the steps of:
(a) each strategy instance providing an estimate of its returns;
(b) using Bayesian inference to assess predefined characteristics of each estimate;
(c) allocating capital to specific strategy instance/instrument pairings depending on the estimated returns and the associated characteristics.

2. The method of claim 1 in which the predefined characteristics relate to the reliability of the estimates.

3. The method of claim 1 further comprising the steps of determining separately
(a) capital allocation for a strategy instance/instrument pairing and (b) trade sizing for that pairing.

4. The method of claim 1 in which each strategy instance provides the estimate of returns in the format of a Gaussian model.

5. The method of claim 4 in which Bayesian inference is used to regression fit the Gaussian models.

6. The method of claim 1 in which time is split into timesteps, the duration of the smallest being determined by the most frequent strategy, with all estimates being updated on each timestep.

7. The method of claim 6 in which a specified input data vector for each timestep is mapped onto a trade duration-return codomain.

8. The method of claim 6 where the trading strategy instance can specify the domain for the function.

9. The method of claim 5 where the strategy instance specifies the functional form for the Bayesian/Gaussian inference through specification of a covariance function.

10. The method of claim 9 where hyperparameters of each functional form are optimized against the data to find the most probable parameters θ_{MP}.

11. The method of claim 9 where multiple models for a single strategy instance are ranked against one another using an evidence maximization approach.

12. The method of claim 11 where only the most probable model is used.

13. The method of claim 11 where all models are used, being first weighted by probability and then summed.

14. The method of claim 1 where the strategy instance provides explicitly parameterized models that are not Gaussian.

15. The method of claim 1 where the Bayesian inference results in a PDF (probability density function) for trade frequency and another for trade duration-return.

16. The method of claim 15 where the PDF for trade frequency is computed using Bayesian inference utilising a Poisson distribution prior.

17. The method of claim 15 where the duration-return and trade frequency PDFs are combined, with the use of a separate estimate of the underlying parameters, given, the triggering of a trading signal, to create a long-run return-per-unit-time PDF.

18. The method of claim 17 including the step of creating a compound predictive model, where the long-run PDF is supplemented by a cross-strategy covariance estimate.

19. The method of claim 18 where the cross-strategy covariance estimate is derived through a factor-analysis of the returns of simulation, combined with an historical simulation for evolution of those factors.

20. The method of claim 17 including the step of performance of capital allocation by a routine, which is provided by the long-run PDF and strategy covariance estimates.

21. The method of claim 20 where this routine is a mean-variance optimizer.

22. The method of claim 20 where the routine utilizes Monte Carlo or queuing theory.

23. The method of claim 20 where the user explicitly provides their own model.

24. The method of claim 1 where capital allocation can be executed according to one of a number of paradigms, including conservative feasible execution, symmetric feasible execution, pre-emptive execution against costs or full pre-emptive execution.

25. The method of claim 1 where trade sizing is performed against the particular output of a current prediction function and the predicted performance for a particular trade is then mapped against the expected long-run performance, to create a relative leverage to use.

26. The method of claim 25 in which the mapping is done by comparing means or modes of the duration-normalized return (specific trade->long run), and then scaling appropriately.

27. The method of claim 25 in which probability density weighting is used.

28. The method of claim 27 in which input data is automatically pruned to the latest n-points to keep the matrix inversion required feasible.

29. The method of claim 28 in which an approximate matrix inversion approach is utilised to allow longer windows of analysis.

30. The method of claim 28 in which a comparison of the chosen, θ_{MP} parameterized model against a ‘null’ model is utilised, over a number of datapoints which is itself set through Bayesian optimization but which will be small relative to the longer window.

31. The method of claim 30 where a transition from a non-null model to the null model causes the longer window to be restarted at that point.

32. The method of claim 1 including the step of using an outer control loop to provide a final constraint to the capital allocation.

33. The method of claim 32 where the control loop operates through the computation of VaR (value at risk).

34. The method of claim 32 where the constraint is fed back as a global multiplier to the size of a single ‘unit’ of allocation, applying equally to all strategies.

35. The method of claim 34 where any changes through this process are implemented pre-emptively.
